(19) United States
(12) Patent Application Publication
(10) Pub. No.: US 2005/0206156 A1
(43) Pub. Date: Sep. 22, 2005

(54) Book with story cards

(76) Inventor: Peter Polick, New York, NY (US)

Correspondence Address: HEDMAN & COSTIGAN P.C., 1185 AVENUE OF THE AMERICAS, NEW YORK, NY, 10036, US

(21) Appl. No.: 10/804,252

(22) Filed: Mar. 19, 2004

(51) Int. Cl. B42D 5/00

(52) U.S. Cl. 281/38

(57) ABSTRACT

A book and a method of using a book having: leaves with pockets capable of housing panels, panels and pages with apertures though which indicia on panels may be incorporated into predefined indicia on the pages.

### BACKGROUND OF THE INVENTION

2. Field of the Invention

This invention relates generally to a book and more specifically to a book with variable and interchangeable indicia. This invention also relates to an interactive book and even more particularly to a book with interchangeable panels with indicia that provide permutations and variations in predefined indicia. This invention also relates to a variable-story story-book and even more particularly to a story book with interchangeable panels with indicia that provide permutations and variations in the story. The present invention also relates to an educational book that provides variable lessons, games and/or quizzes. The present invention also relates to a method for providing variations and permutations in predefined indicia content of the book.

2. Description of the Related Art

Reading is a highly rewarding activity as well as an important skill that can only be mastered through practice. However, as parents and teachers well know, keeping a young reader interested in books is not always an easy task. Parents and teachers constantly battle for children's attention, fighting increasing competition from video or computer games and/or the more passive media such as television that, in particular, leaves little, if anything, up to the viewer's imagination. Books on the other hand provide a uniquely enriching experience. The written word is unique in its ability to convey information, often in ways superior to those of different means of communication. Consequently, reading may spark the imagination and provide perhaps a more vivid experience than other sources of entertainment and information are capable of providing. For these and many other reasons, including helping to spur cognitive development and building vocabulary, good reading habits particularly are encouraged at a young age.

Today's increasingly visual entertainment and media provide ultra fast paced, dynamic and sometimes simplistic entertainment. The appeal of an unchanging story line of a book might pale in comparison to other entertainment and educational choices available today. While novelty, variety and change may have an inherent appeal, independent of content, traditional books, with their immutable textual or graphical content, may seem stale or stagnant to today's readers, again, independent of content. Younger readers, in particular, may forgo the effort and, consequently, the ultimate satisfaction and pleasure of developing reading skills in favor of seeking more dynamic, easily accessible forms of entertainment.

The educational value of books and the written word are well recognized in the prior art as are their sometimes-limited appeal. Many inventions have attempted to liven up printed materials. For example, U.S. Pat. No. 5,466,158 discloses an interactive printed book that allows the reader to respond to challenges posed by the printed material by exerting pressure on specially marked areas on the printed page. This patent discloses reader interaction by closing an electrical circuit disposed in a sensitive upper surface of a base unit, upon which the printed material is placed. Sound effects and logical challenges for stories are stored in a replaceable cartridge and any number of different printed materials can be used as long as the specific cartridge for each different printed material is inserted into the base unit. U.S. Pat. No. 5,374,194 discloses a talking book with voice chips activated by electronic switches located in inserts placed in lateral channels that open to the binding-facing edges of the pages. U.S. Pat. No. 6,405,167 discloses an interactive book for associating verbalized words with written words wherein a diode or liquid crystal display can highlight or illuminate various words. This patent further discloses a book with various words and phrases that constitute a single story or multiple stories, and alternatively, a changeable electronic display that could, based upon the user's input, display various pages of a book. U.S. Pat. No. 5,306,155 discloses a tear-off pad with bundles of pages with identical leaves each having an identical picture, no text, and space for the user to formulate his or her own story in relation to the picture on the page. U.S. Pat. No. 5,447,439 discloses an interactive story book providing informative elements, blank spaces and stickers and/or slide panels to provide a second informative element that the child selects to most closely match the first informative element. The disclosure of this patent teaches individual, independent stickers and slide panels, which either are not removable or not properly interchangeable and are not capable of providing, in context, permutations into other pages. U.S. Pat. No. 5,409,381 discloses a device for teaching reading and writing using various moveable overlaying display members. U.S. Pat. No. 4,757,580 discloses a story book with apertures and optical viewers for viewing scenes depicted on transparencies housed in the rear cover.

Much of the prior art that provides interactive or variable textual or graphical entertainment teaches complicated, flashy, video-based or electronic devices. Many of the prior art devices fall well short of providing the educational, imagination-building, reading-skill-developing and simple enjoyment available in a book. The prior art devices typically are cumbersome, expensive, and frequently depend on an electronic or mechanical interface. In these devices, any interaction is effected by the push of a button, tending to distance the user from the interactive nature of the experience. Such expedients obviate any physical three-dimensional visuospatial interaction or challenges. Where the prior art does not require electrical connections and/or interfaces, it lacks the ability to provide the user a truly flexible, interchangeable means for introducing permutations into predefined text, graphics or the like throughout various pages of the book. A long felt need in the art would be solved if a book format could be developed that overcame the deficiencies of the prior art.

### SUMMARY OF THE INVENTION

The present invention provides a novel book and methods of using the book that overcomes the deficiencies of the prior art. The present invention allows the reader to be inspired through text and/or pictures and also to create and interact with the book in a myriad of tangible, intellectual, emotional and/or artistic ways, without the necessity of electronics. The present invention provides a fun, educational and interactive book that offers numerous optional permutations and user-implemented changes at predefined sections throughout the text. The method, system and device for changing the text provide entertaining, interesting, challenging and imagination and dexterity-building activities. The enjoyment and utility of the present invention also may change and develop over time corresponding to its degree of use, beginning with providing new, unpredictable, seemingly random permutations, and then later as the book and its panels become more familiar to the reader, providing rewarding memory challenges to the reader that may take the form of a game or activity, requiring the reader to remember different setups or configurations to complete indicia in a particular way.

### BRIEF DESCRIPTION OF THE DRAWINGS

FIG. 1 is a perspective view of a preferred embodiment.

FIG. 2 is a perspective view of various leaf components of a preferred embodiment.

FIG. 3 is a plan view of various leaf components of a preferred embodiment.

FIG. 4 is a plan view of whole sheet designed to incorporate a double gatefold in a preferred embodiment.

FIG. 5 is a plan view showing examples of panels and pages of preferred embodiments.

FIG. 6 is a plan view of a pocket-containing leaf with panel of a preferred embodiment.

### DETAILED DESCRIPTION OF PREFERRED EMBODIMENTS

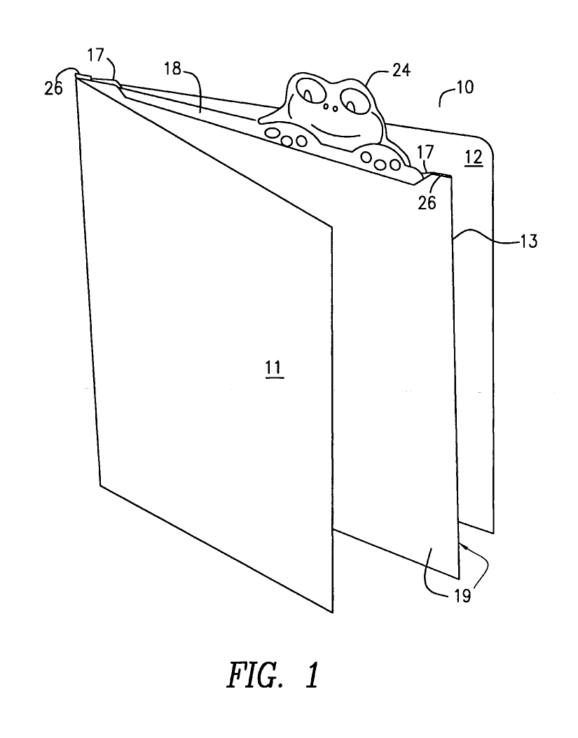

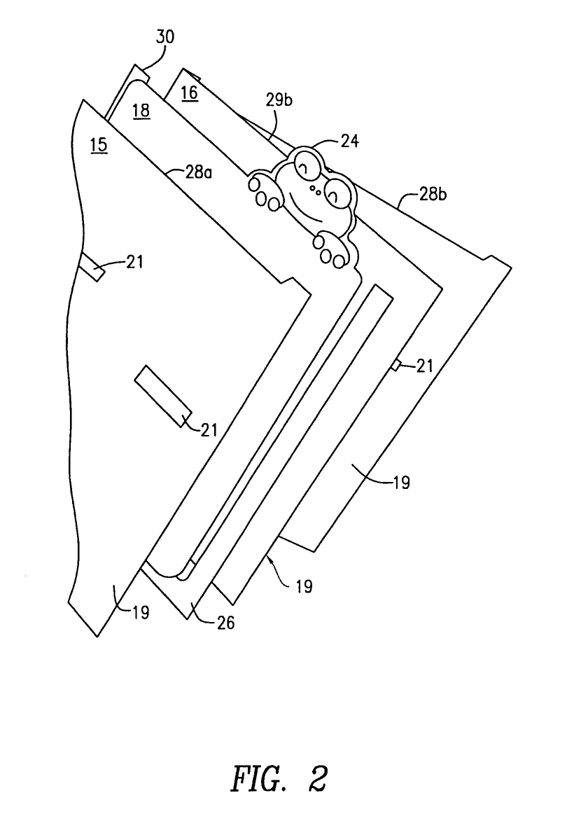

Referring to FIGS. 1 and 2, the present invention provides a book 10 that may comprise a front cover 11, a back cover 12 and one or more leaves 13 in between. The leaves 13 of the book 10 comprise a pocket 17 disposed between a front wall 15, and a back wall 16. The outer surfaces of the walls 15, 16 each comprise a separate page 19 capable of containing viewable indicia. The walls 15, 16 provide a housing for panels 18 that can be removably inserted into the pocket 17.

FIGS. 1 and 2 also show an embodiment of the present invention wherein the leaves of the book comprise a spacer 26 disposed between the walls 15, 16. Spacer 26 and walls 15, 16 are sized and shaped to securely and removably house panel 18, with the spacer 26 capable of delimiting the interior perimeter of the pocket 17. It can also be appreciated that in other embodiments, the walls 15, 16 may be bound directly together on along a portion of their inside surfaces, preferably around a portion of an interior perimeter section, to form the pocket 17, without incorporating a spacer 26. In the embodiments without a spacer 26, the walls 15, 16 and the panels 18 will be selected from shapes, sizes and materials that allow panels 18 to be securely and removably inserted into the pockets 17.

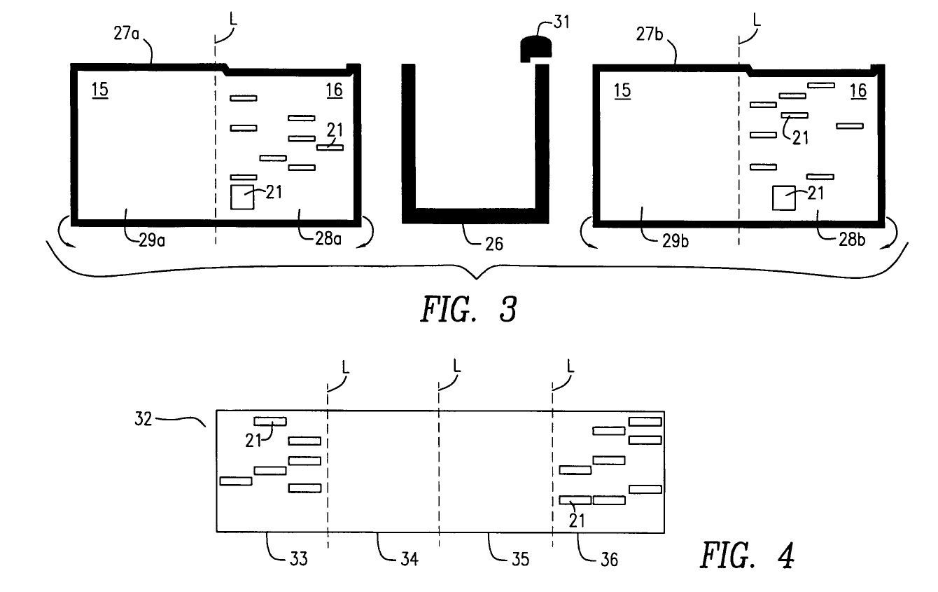

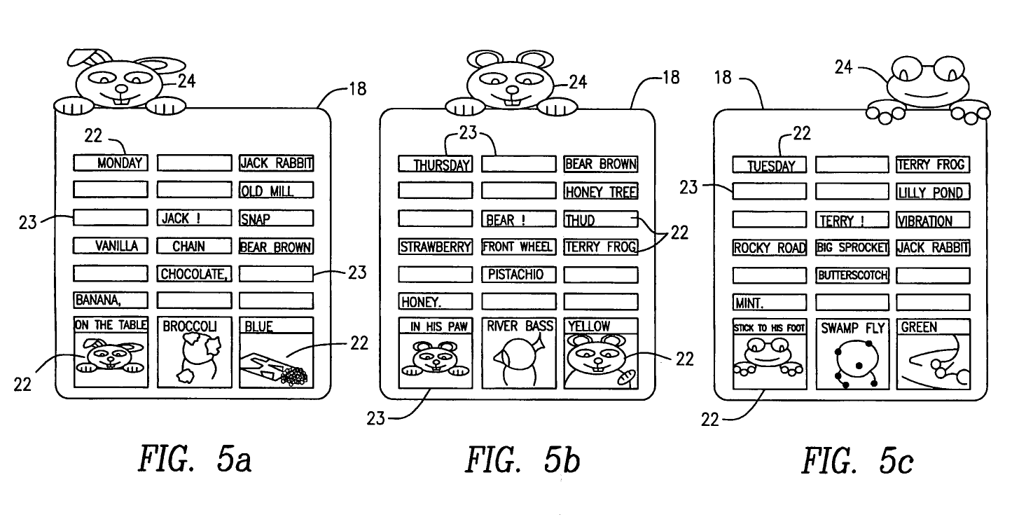

As shown in FIG. 3, each wall 15, 16 may be comprised of one half of a whole sheet 27. FIG. 3 shows two whole sheets, 27a, 27b, prior to being folded in half along a vertical axis, denoted by dashed line L. When whole sheets 27a, 27b are folded in half along vertical axis L, two right half sheets 28a, 28b and two left half sheets 29a, 29b are formed. Crease 30 is formed, as shown in FIG. 2, when whole sheet 27b is folded along vertical axis (line L in FIG. 3) in the direction shown by the arrows in FIG. 3. FIG. 2 shows right half 28a of folded whole sheet 27a and left half sheet 29b of folded whole sheet 27b aligned back to back with spacer 26 in between. Merely for perspective, FIG. 2 also shows panel 18 disposed in between right half 28a and left half 29b, and ready to be positioned within the perimeter of the internal edges of spacer 26. Optionally, a whole sheet may be a double length whole sheet 32, i.e., twice as long as whole sheet 27 as measured along an axis perpendicularly to axis L, and configured appropriately with two additional folds along vertical axis L to provide double gatefolds 33, 36 on both half sides, as shown in the FIG. 4. Thus, a double length whole sheet 32 comprises four sections, a first quarter section 33 that operates as a first gatefold, a second quarter section 34 that may form a back wall of a pocket-containing leaf or may form a front cover of the book, a third quarter section 35 that may form a front wall of a pocket-containing leaf or may form a back cover of the book and a fourth section 36 that forms a second gatefold. It should be apparent to one of ordinary skill in the art based on the above description that the book may also comprise a single gatefold comprising a 3/2-length whole sheet comprising three sections of approximately equal length, with two folds along a vertical axis (not shown). Where the terms “half” “third,” “fourth” or “quarter” are used herein in the specification and/or in the claims, these terms are not to be construed as indicating an exact measurement, denoting any part or parts of exactly equal proportions; these terms should be construed, for purposes of this invention, to include slight variations and deviations, intended or otherwise, in the proportions of any components of the present invention indicated thereby.

In embodiments incorporating a spacer, spacer 26 is preferably approximately U-shaped, preferably disposed around the inside perimeter of walls 15,16 and optionally may comprise a removable latching or locking device 31, shown in FIG. 3, capable of being removably attached, for example by snapping onto the top of one side of the U, to lock a panel 18 into a pocket 17. Spacer 26 is of a particular thickness, shape and dimension to provide a secure housing for removable panels 18. Spacer 26 optionally may comprise adhesive on both sides so that the leaf 13 may be formed by pressing half sheets 28a, 29b together, one onto each side of spacer 26. In the embodiments incorporating a spacer 26, the walls 15, 16, as well as panels 18 are preferably constructed of a heavy paper or cardboard material such that both leaf 13 and panel 18 are capable of maintaining their shape.

Clearly, a practically unlimited number of leaves 13, pockets 17 and pages 19 can be incorporated into a book by binding whole sheets 27 in a chain-like fashion, using the above-described construction. As is clear from the above-described construction, when the desired number of leaves 13, pockets 17 and pages 19 are obtained, a separate cover may be added by binding the remaining available first left half sheet 29a and the remaining available last right half sheet 28b to the inside of the front, or left half, binding cover 11 and to the inside of the back, or right half, binding cover 12, respectively. The separate book cover may be formed from one continuous cover sheet with a middle or spine portion (not shown) approximately equal to the width of the sum of leaves 13, with front cover 11 and a back cover 12, each approximately equal in size to leaves 13. The continuous cover sheet optionally may be larger, along any dimension, than the leaves 13 it encloses for aesthetic or practical purposes, such as housing optional devices. In other embodiments, the remaining available first left half sheet 29a and the remaining last right hand sheet 28b may themselves form a front cover 11 and a back cover 12, respectively.

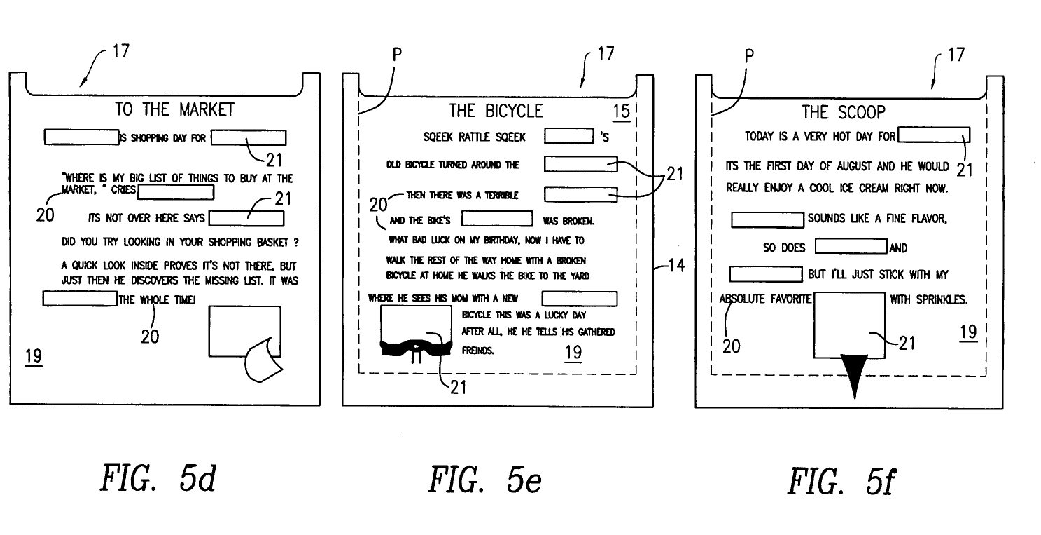

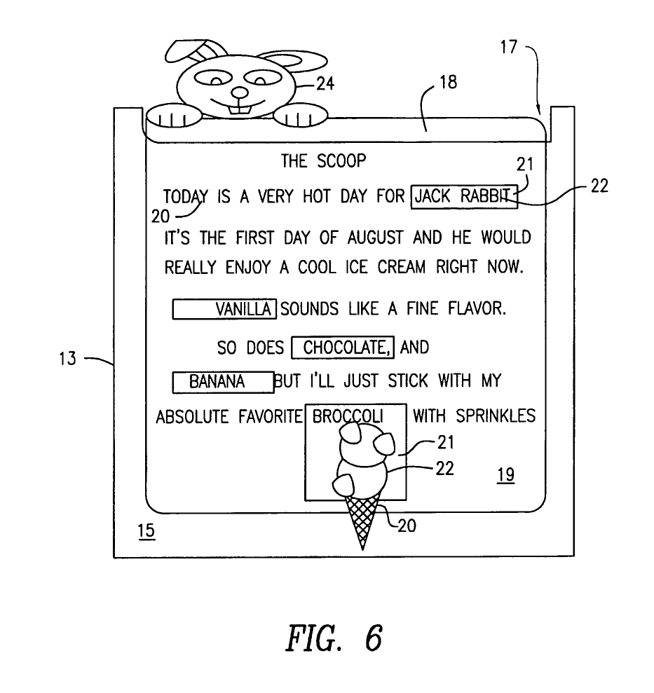

Referring now to FIGS. 5 and 6, various examples are shown of a page 19 comprising predefined indicia 20 and of a panel 18 comprising panel indicia 22. Predefined indicia 20 and/or panel indicia 22 may include, without limitation, text, graphics, photographs, pictures, colors, shapes, drawings, Braille and the like. In preferred embodiments, page 19 contains an aperture or apertures 21 typically aligned and sized to introduce blank spaces into a selected portion of predefined indicia 20 and to cooperate with panel indicia 22 located on panels 18. One or both outer surfaces of panel 18 optionally may comprise panel indicia 22. Each panel 18 may be removably but securely inserted into at least one pocket 17 of book 10. Dashed line P in FIGS. 5e and 5f indicate the inside perimeter of spacer 26, located internally to walls 15,16 which guides panel 18 into its correct position within pocket 17.

As shown in the examples in FIG. 5, when a panel 18 is viewed alone, i.e., outside of pocket 17, it may appear to contain merely a jumble of panel indicia 22 on either or both sides of the panel 18. In actuality however, the panel indicia 22 are customized to be selectively viewed through cooperating apertures 21 located throughout the various pages 19 of the book 10. FIG. 6 shows, by way of one example, the result of inserting the panel 18 of FIG. 5a into the pocket 17 behind the page 19 shown in FIG. 5f, thereby causing the panel indicia 22 to be viewable through the apertures 21 and introducing one variation into predefined indicia 20 to complete the story ‘The Scoop’ contained on that page.

In preferred embodiments, shown in FIG. 5, the panel indicia 22 are arranged within fields 23 located at predetermined positions so that panel indicia 22 contained in the fields 23 will be viewable through cooperating apertures 21 on a page 19. The panel indicia 22 may be arranged within the fields 23 so that they are relevant to the predefined indicia 20 on a particular page containing the particular cooperating aperture 21 through which they are viewed. The indicia fields 23 may be customized and populated in a practically unlimited number of possible configurations.

FIG. 5 further demonstrates the interchangeability of panels 18 for insertion into different pockets 17. In preferred embodiments, each side of a panel completes predefined indicia on a page in a different way, providing a huge variety of panel indicia and predefined indicia to mix and match. By way of an example, in an embodiment with just five leaves, five corresponding pockets and five double-sided panels, i.e. ten panel faces, the reader may insert the five different panels into the five different pockets in any order and any orientation she chooses, mixing and matching to create as many as 3,840 permutations (5!×2⁵).

In other preferred embodiments, the panels may comprise tabular indicia or identifying indicia, which is indicia that may identify the panels to the user in useful, potentially amusing ways. For example, as shown in the various figures, the top portion of panels 18 may have a tabular section 24 that will identify the panel to the user even when it is inserted in a pocket 17. In still other embodiments, the panels 18 may be provided in sets that relate to a particular theme. In these embodiments, the panels 18 may be coded with identifying indicia that identify the theme to the user. For example, tabular sections 24 may depict various land animals that will identify that set of panels to the user as providing variations in a story that relate to characters, issues, art or facts about land animals. By way of another example, the tabular indicia may depict fish, and indicate to the user that those panels provide permutations in the predefined indicia 20 that relate to characters, issues, art or facts about fish. Similarly, other examples include, but are not limited to dinosaurs, insects and people such as historical figures and the like. For educational purposes, the predefined indicia and the panel indicia may relate to educational categories and the tabular indicia similarly may indicate the subject matter of a lesson, review, or quiz. Educational categories include, but are not limited to, history, geography, science, social studies, spelling, mathematics, religion, psychology, biology, chemistry, language study, physical education and the like. For entertainment and/or educational purposes, the page indicia, panel indicia and tabular indicia all may relate to any topic whatsoever.

In another embodiment, a method of using the book of the present invention may comprise a game-like activity. Panels may be supplied with blank panel indicia fields and the user may populate the panel indicia fields in any desired fashion. In one example, panels may provide categorical indicia, which are suggestions for user-created indicia based on the use of that indicia field on the various pages. Categorical indicia includes pictures or text, for example, the words “noun,” “proper noun,” “main character,” “adjective,” “color,” “favorite food,” or the like, inscribed in small lettering beneath a blank panel indicia field to indicate to the user how to populate that field. In another example, the panels may be completely blank such that the entire panel is one indicia field and all apertures are in aligned relation to, and therefore cooperate with, the single, panel-sized indicia field. This particular example provides a means to create, for example, a silly or nonsensical story or ‘abstract’ art based on spontaneously user-created panel indicia that, when the panel is inserted into a pocket, will be incorporated into the predefined indicia on the pages in practically unpredictable ways.

Alternatively, the user may fill in blank indicia fields with a panel already inserted into a pocket, using the predefined indicia on a page that suggests a story as a guide for selecting the user-defined indicia to incorporate onto the panel. In this way, the user may create his or her own characters and character studies on a panel based on a story on one page and then incorporate the user-created characters into other actions and stories by inserting the panel with the user-created character information into other pockets. In preferred embodiments, a pen assembly may be provided, preferably on or within the book cover, most preferably located on the inside back cover on a portion extending below the leaves of the book. The pen assembly may removeably hold one or more pens or other writing implements, for easy and convenient user access for completing user-defined indicia.

In yet other embodiments, the panels may be comprised of indicia in such a manner that they are practically invisible to the naked eye. In one example, the apertures may comprise a selectively translucent filter that can be used to reveal the hidden indicia on the panels when they are inserted into the pockets. Such combinations of “invisible” indicia and translucent filters that reveal the hidden indicia are well know to one skilled in the art and do not require further explanation here. This embodiment may be used simply as another novel and interesting way to keep children interested in reading and also may be used in educational settings, providing, for example, methods for reviewing academic or other materials and for administering self-quizzes. For example, a panel may contain tabular indicia indicating a continent, and predefined indicia on the pages may contain statements such as “The continent of [aperture] is made up of [aperture] countries, the largest of which is [aperture].” Once a panel is inserted, those statements are completed with panel indicia and become accurate and relevant to the continent indicated by the tabular indicia on a panel with the hidden text. Another possibility is to have the page indicia include sets of numbers and the panel indicia include an arithmetic operator and answers accurate with relation to the operator and the sets of numbers of the page indicia.

The use of the present invention as a learning, memory, study or academic aid is not limited to embodiments comprising hidden indicia. As can be seen from the foregoing description, the present invention also may be used in a multitude of activities such as: review of educational materials; sports facts, statistics and/or trivia activities; introducing new themes and characters into stories; and/or introducing numerous hidden, surprise permutations into stories that deal with mystery, surprise or the like. It can also be appreciated that the aperture and field combinations may be customized to reveal clues in the form of partial words, single letters, or selected portions of a graphic, picture, photograph or the like for solving mystery-type stories or riddles. The apertures may also be fitted with closing means such as flaps, slides, shades, rotors or the like, all well known in the art, so that the reader may have to open a flap or turn a rotor to reveal indicia provided behind the aperture on the panel, or alternatively close a flap or turn a rotor comprising a viewing device in order to reveal hidden indicia on a panel.

In still other embodiments, the book may comprise one or more lengthy, complicated and/or intricate stories or graphics that allow or require numerous and more intricate permutations in indicia. In these embodiments, a manual or guide may accompany the book and panels of the present invention to provide guidance or suggestions for achieving various outcomes by, for example, suggesting the order and/or orientation of panels for placement in the pockets of the various leaves.

In yet other embodiments, the present invention provides audio and/or visual feedback to the user upon inserting a panel into a pocket. For example, one particular sound may be played in response to a panel being inserted into a pocket and a different sound played in response to the panel being taken out of the pocket. In a similar fashion, differently colored lights may flash depending on whether a panel is inserted or removed. Particular sequences of flashing lights also may be played depending on the action of the user. In any of these embodiments, the audio and/or visual feedback also may be customized to the particular panel being inserted into, or removed from, a particular pocket. When the book allows for more elaborate permutations, such that an accompanying guide or manual might provide instructions to achieve different results, the feedback may provide indications of success of completing a particular instruction. Even without a written guide or manual, the feedback may indicate a next step to be taken by the user. Methods for producing the audio and/or visual responses include placing sensors inside the pockets. Panel indicators also may be provided on or within the panels to provide a customized feedback response when the panel indicator interacts with the pocket sensor. Electronic means for effecting the audio and/or visual feedback are well known to one skilled in the art and need not be elaborated upon herein.

In another embodiment, the present invention may comprise sets of panels for each leaf, with the number of sets provided equal to the number of leafs. The panels may be constructed and shaped so that only panels from one set will fit into each leaf. The permutations and variations in these embodiments derive from pairing different panels from different sets with each other. Additionally, any type of binding of one page to another that is known to those skilled in the art can be employed in the practice of the present invention.

Many variations of the present invention will suggest themselves to those skilled in the art in light of the above-detailed description. All such obvious modifications are within the full intended scope of the appended claims. All of the above-referenced patents, patent applications and publications are hereby incorporated by reference in their entirety.

1. A book comprising at least one removable panel and at least one pocket-containing leaf, said pocket-containing leaf comprising, a front wall, and a back wall to thereby form a pocket disposed between said front wall and said back wall, said pocket adapted to removably receive said panel, said front wall comprising an outer surface comprising a first page, said back wall comprising an outer surface comprising a second page, wherein at least one of said pages comprises predefined indicia and at least one aperture, wherein said panel comprises at least one panel indicia field and wherein said at least one aperture is positioned in aligned relation to one of said panel indicia fields when said panel is inserted into said pocket.

2. The book of claim 1 wherein said front wall comprises one half of a first whole sheet and said back wall comprises one half of a second whole sheet.

3. The book of claim 1 wherein said front wall and said back wall are fastened directly to one another along reciprocal, facing perimeter sections of said front and back walls.

4. The book of claim 1 wherein said leaves further comprise a spacer disposed between said front wall and said back wall.

5. The book of claim 4 wherein said pocket-containing leaves are formed by binding said one half of a first whole sheet to a first surface of said spacer and binding said one half of a second whole sheet folded in half to a second surface of said spacer wherein said first and second spacer surfaces are opposite sides of said spacer.

6. The book of claim 1 wherein said panel further comprises panel indicia disposed within at least one of said indicia fields.

7. The book of claim 1 wherein said panel is adapted to receive user-created panel indicia within at least one of said indicia fields.

8. The book of claim 7 wherein said panel further comprises categorical indicia to assist a user in selecting said user-defined indicia.

9. The book of claim 1 wherein said panel further comprises a tabular section comprising tabular indicia.

10. The book of claim 9 wherein said tabular indicia and said panel indicia relate to a common theme.

11. The book of claim 4 wherein said spacer comprises a removably attachable locking mechanism capable of securing said panel in said pocket.

12. The book of claim 2 wherein a second half of said first whole sheet operates as a front cover and a second half of said second whole sheet operates as a back cover.

13. The book of claim 2 further comprising a first pocket-containing leaf and a last pocket-containing leaf.

14. The book of claim 10 wherein a second half of said first whole sheet of said first pocket-containing leaf operates as a front cover and a second half of said second whole sheet of said last pocket-containing leaf operates as a back cover.

15. The book of claim 2 comprising a separate cover wherein a second half of said first whole sheet is bound to an inside of a front portion of said cover and wherein a second half of said second whole sheet is bound to an inside of a back portion of said cover

16. The book of claim 10 comprising a separate cover wherein a second half of said first whole sheet of said first pocket-containing leaf is bound to an inside of a front portion of said cover and wherein a second half of said second whole sheet of said last pocket-containing leaf is bound to an inside of a back portion of said cover.

17. The book of claim 2 further comprising at least one double gatefold comprising a whole sheet folded into quarter sections, said whole sheet comprising a first section that operates as a first gatefold, a second section, a third section and a fourth section that operates as a second gatefold.

18. The book of claim 2 further comprising at least one single gatefold comprising a whole sheet folded in thirds, said whole sheet comprising a first section that operates as a gatefold, a second section and third section.

19. The book of claim 1 wherein said aperture further comprises a closing means.

20. The book of claim 16 wherein said closing means is selected from the group consisting of flaps, slides, shades and rotors.

21. The book of claim 3 wherein at least one page comprises story-based predefined indicia and said panel indicia comprise story-based indicia.

22. The book of claim 3 wherein at least one page comprises predefined indicia relating to educational categories and said panel indicia relates to educational categories.

23. The book of claim 3 wherein said panel indicia are invisible to the naked eye and wherein said apertures comprise a visual-aid device capable of revealing said invisible panel indicia.

24. A method of completing gaps in predefined indicia on a page comprising at least one aperture, said method comprising inserting a panel comprising panel indicia into a pocket in a pocket-containing leaf comprising a spacer such that said panel indicia is viewable on said page through said aperture.

25. A method of introducing permutations into predefined indicia on a page comprising at lease one aperture, said method comprising removing a panel comprising first panel indicia from a pocket in a pocket-containing leaf and inserting a panel comprising second panel indicia into said pocket such that said second panel indicia are viewable on said page through said aperture.

26. The method of claim 22 wherein said predefined indicia, said first panel indicia and said second panel indicia comprise story-related indicia.

27. The method of claim 22 wherein said predefined indicia, said first panel indicia and said second panel indicia relate to educational categories.

28. The book of claim 1 further comprising an assembly for removably holding at least one writing implement.

29. A method of using the book of claim 4 comprising populating said indicia fields with user-defined indicia without reference to said predefined indicia, inserting said panel comprising said user-populated indicia fields into said pocket, viewing said pre-defined and user-defined indicia combinations.

30. A method of using the book of claim 4 comprising inserting a panel into a first pocket, populating said indicia fields with user-defined indicia with reference to said predefined indicia on a first page, removing said panel comprising user-defined indicia and inserting said panel comprising user-defined indicia into a second pocket.

31. The book of claim 1 further comprising means for producing an audio or visual response to a user-initiated action.

32. The book of claim 31 wherein said audio or visual response is unique to each user-initiated action selected from a set of defined user-initiated actions.

33. The book of claim 31 wherein said audio or visual response is elicited by movement of said panel within said pocket.

34. The book of claim 33 wherein said audio or visual response is unique to each panel in a set of panels.
